(19) United States
(12) Patent Application Publication
(10) Pub. No.: US 2026/0342444 A1
(43) Pub. Date: Oct. 29, 2026

(54) LIGHT DETECTION ELEMENT

(71) Applicant: TDK Corporation, Tokyo (JP)

(72) Inventor: Yusho HIRATA, Tokyo (JP)

(73) Assignee: TDK Corporation, Tokyo (JP)

(21) Appl. No.: 19/652,102

(22) Filed: Apr. 20, 2026

(30) Foreign Application Priority Data
Apr. 24, 2025 (JP) 2025-072579

(51) Int. Cl. H04B 10/40; G01J 1/44; H01Q 1/22

(52) U.S. Cl. CPC H04B 10/40; G01J 1/44; H01Q 1/22

(57) ABSTRACT

The light detection element includes a light detection portion 10 for detecting light, a first electrode 11 having optical transparency, a second electrode 12, and an antenna portion 20. The light detection portion 10 is a magnetic element such as an MTJ element. The light detection portion 10 is located between the first electrode 11 and the second electrode 12, and the antenna portion 20 is composed of one or more metal rings 21, 22 formed on the surface of either the first electrode 11 or the second electrode 12 on the light detection portion 10 side, with the light detection portion 10 at the center.

### CROSS-REFERENCE TO RELATED APPLICATION

This application claims a priority, under the Paris Convention, to Japanese Patent Application No. 2025-072579 filed on Apr. 24, 2025, the entirety of which is incorporated herein by reference.

### TECHNICAL FIELD

The present disclosure relates to a light detection element.

### BACKGROUND

Photoelectric conversion elements such as light detection elements are used for various purposes. For example, Japanese Patent Application Publication No. 2001-292107 describes a receiving device that receives optical signals using a photodiode. The photodiode is, for example, a pn junction diode using a semiconductor pn junction, and converts light into an electrical signal. For example, US Patent No. 9842874 describes an optical sensor using a semiconductor pn junction and an image sensor using this optical sensor.

Furthermore, for example, Japanese Patent Application Publication No. 2022-69387 discloses an optical sensor using a magnetic element and a receiving device using this optical sensor, and Japanese Patent Application Publication No. 2023-110453 discloses a technology that combines an optical sensor using a magnetic element with a metalens.

As recognized by the present inventor, in order to provide a light detection element with good photoelectric conversion efficiency, a technology is required to efficiently irradiate incident light onto a light detection element such as an MTJ (Magnetic Tunnel Junction) element. The light detection element can be formed into a cylindrical shape with a diameter of 100 nm or less. On the other hand, it is difficult to make the spot diameter of the light focused by a lens or the like smaller than the wavelength of the light (a few μm) due to the diffraction limit. For this reason, when a small light detection portion is irradiated with light, most of the light strikes areas other than the light detection portion, resulting in losses.

### SUMMARY

One aspect of the present disclosure provides a light detection element according to the present disclosure comprises a light detection portion for detecting light, a first electrode having optical transparency that is light-transmissive, a second electrode, and an antenna portion, the light detection portion being located between the first electrode and the second electrode, and the antenna portion being made of one or more metal rings formed on the surface of either the first electrode or the second electrode facing the light detection portion, with the light detection portion at the center.

### BRIEF DESCRIPTION OF DRAWINGS

FIG. 1 shows a plan view showing the configuration of a light detection element according to a first embodiment of the present disclosure.

FIG. 2 shows a cross-sectional view taken along line II-II in FIG. 1.

FIG. 3 shows a partially enlarged cross-sectional view showing the configuration of the magnetic element shown in FIG. 2.

FIG. 4 shows a plan view showing the configuration of a light detection element used in Simulation 1.

FIG. 5 shows a cross-sectional view taken along line V-V in FIG. 4.

FIG. 6 shows a graph showing the simulation results of the amount of light absorption by an MTJ pillar when irradiated with light.

FIG. 7A shows the simulation results of the electric field strength distribution at point A in FIG. 6.

FIG. 7B shows the simulation results of the electric field strength distribution at point B in FIG. 6.

FIG. 7C shows the simulation results of the electric field strength distribution at point C in FIG. 6.

FIG. 8 shows a plan view showing the configuration of a light detection element used in Simulation 2.

FIG. 9 shows a cross-sectional view taken along line IX-IX in FIG. 8.

FIG. 10 shows a diagram showing simulation results of the dependence of light absorption in the MTJ pillar on the metal ring interval R and wavelength λ.

FIG. 11 shows a diagram showing the preferred range of metal ring interval R and wavelength λ from the simulation results of FIG. 10.

FIG. 12 shows a graph showing the simulation results of the relationship between the MTJ pillar radius and the amount of light absorption per unit volume of the MTJ pillar.

FIG. 13 shows a cross-sectional view showing the configuration of a light detection element according to a second embodiment of the present disclosure.

FIG. 14 shows a cross-sectional view showing the configuration of a light detection element according to a third embodiment of the present disclosure.

### DETAILED DESCRIPTION

According to the present disclosure, by providing an antenna portion on the side of a light detection element consisting of an MTJ pillar or the like, it is possible to utilize plasmon resonance to focus light in an area narrower than the diffraction limit of light, thereby improving the sensitivity of the light detection element.

Embodiments of the present disclosure will be described in detail below with reference to the drawings.

To facilitate understanding of this disclosure, the scale of each part in the drawings may differ from the actual scale. In the xyz Cartesian coordinate system set in the figure, the x-axis and y-axis directions are horizontal, and the z-axis direction is vertical. The positive direction of the z-axis is also called the upward direction, and the negative direction of the z-axis is also called the downward direction, but they are not related to the direction of gravity. In the directions of parallel, right angles, orthogonal, horizontal, vertical, up and down, left and right, etc., deviations are allowed to a degree that does not impair the effect of the embodiment. In addition, "~" indicating a numerical range means that the numerical values written before and after it are included as the lower and upper limits.

First, the first embodiment of the present disclosure will be described.

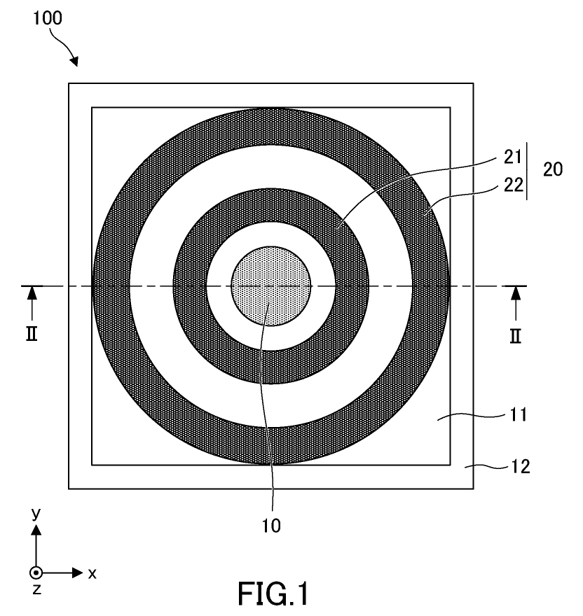

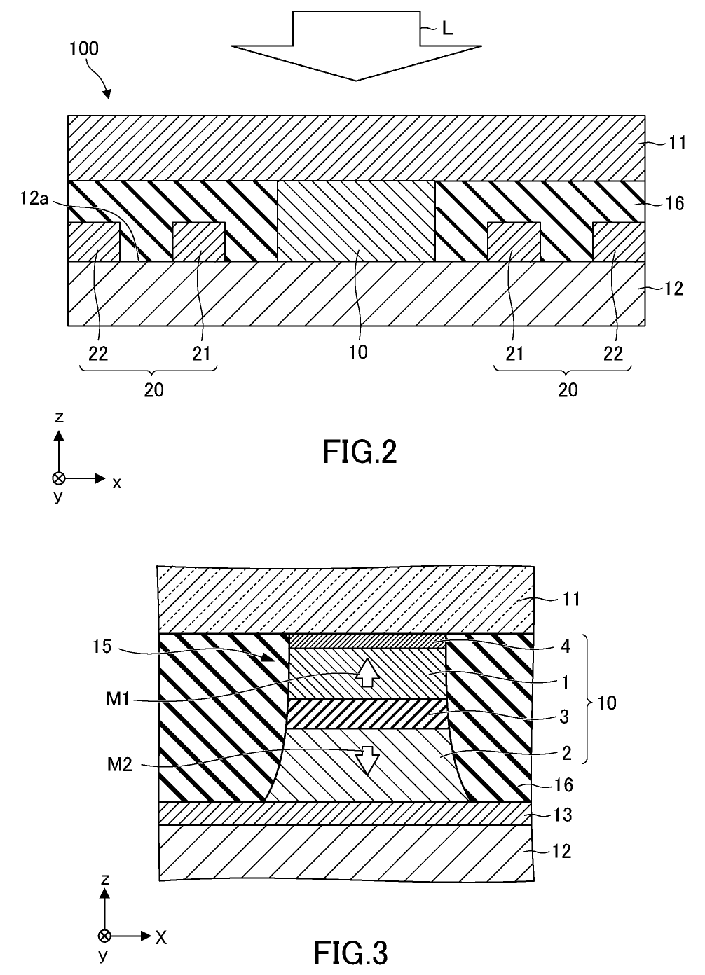

FIG. 1 is a plan view showing the configuration of a light detection element 100 according to a first embodiment of the present disclosure, and FIG. 2 is a cross-sectional view taken along line II-II in FIG. 1. As shown in FIGS. 1 and 2, the light detection element 100 includes a light detection portion 10 that detects light, a first electrode 11 that is optically transparent or transparent, a second electrode 12, and an antenna portion 20. The light detection portion 10 is located between the first electrode 11 and the second electrode 12. The antenna portion 20 is also called a plasmon antenna or a bull's-eye antenna, and is composed of one or more metal rings 21, 22 formed on the second electrode 12 with the light detection portion 10 at the center. The light detection element 100 is, for example, a spin light detection element, and its shape may be a columnar shape, for example, a rectangular columnar shape, a cylindrical shape, etc. In this embodiment, the light detection portion 10 is a magnetic element such as an MTJ element, as will be described later, and in the following description, the "light detection portion" is also referred to as a magnetic element.

Light L incident on the light detection element 100 passes through the transparent first electrode 11 and is irradiated to the magnetic element 10, which is the light detection portion. The magnetic element 10 detects the irradiated light and converts it into an electrical signal. This electrical signal is extracted using the first electrode 11 and the second electrode 12 provided above and below the magnetic element 10.

The "light" described in this specification is not limited to visible light, but may be infrared light, which has a longer wavelength than visible light, or ultraviolet light, which has a shorter wavelength than visible light. The wavelength of visible light is, for example, 380 nm or more and less than 800 nm. The wavelength of infrared light is, for example, 800 nm or more and 1 mm or less. The wavelength of ultraviolet light is, for example, 200 nm or more and less than 380 nm.

Each component will be explained below.

FIG. 3 is a partially enlarged cross-sectional view showing the configuration of the magnetic element 10 of FIG. 1. As shown in FIG. 3, the magnetic element 10 includes at least a first ferromagnetic layer 1, a second ferromagnetic layer 2, and a spacer layer 3 sandwiched between the first ferromagnetic layer 1 and the second ferromagnetic layer 2. In FIG. 3, the second ferromagnetic layer 2, the spacer layer 3, the first ferromagnetic layer 1, and the cap layer 4 are stacked in this order in the positive direction of the z-axis to form a laminate 15. The laminate 15 constituting the magnetic element 10 may further include other layers such as a third ferromagnetic layer, a buffer layer, a seed layer, a magnetic coupling layer, and a perpendicular magnetization induction layer as necessary.

As shown in FIG. 3, a first electrode 11 is formed on the upper side of the laminate 15, and a second electrode 12 is formed on the lower side of the laminate 15 through a cap layer 13. The magnetic element 10 may include the first electrode 11, the second electrode 12, the cap layer 13, the insulating layer 16, etc. in addition to the laminate 15. The cap layer 4 is located between the first ferromagnetic layer 1 and the first electrode 11, and the cap layer 13 is located between the second ferromagnetic layer 2 and the second electrode 12. The insulating layer 16 is formed between the first electrode 11 and the cap layer 13 or the second electrode 12, and is provided so as to cover the periphery of the laminate 15.

The magnetic element 10 is, for example, an MTJ element in which the spacer layer 3 is made of an insulating material. In this case, the magnetic element 10 can exhibit a tunnel magnetoresistance (TMR) effect. The resistance value of the magnetic element 10 changes when it is irradiated with light from the outside. In the magnetic element 10, the resistance value in the z-axis direction (resistance value when a current flows in the z-axis direction) changes according to the relative change between the state of the magnetization M1 of the first ferromagnetic layer 1 and the state of the magnetization M2 of the second ferromagnetic layer 2. For example, the resistance value in the z-axis direction of the magnetic element 10 changes according to the change in the relative angle between the direction of the magnetization M1 of the first ferromagnetic layer 1 and the direction of the magnetization M2 of the second ferromagnetic layer 2. In addition, for example, the resistance value in the z-axis direction of the magnetic element 10 changes according to the change in the magnitude of the magnetization M1 of the first ferromagnetic layer 1.

In addition, for example, when the spacer layer 3 is made of metal, the magnetic element 10 can exhibit a giant magnetoresistance (GMR) effect. Such an element is called a GMR element. Even when the magnetic element 10 is a GMR element, the resistance value in the z-axis direction (resistance value when a current flows in the z-axis direction) changes according to the relative change between the state of magnetization M1 of the first ferromagnetic layer 1 and the state of magnetization M2 of the second ferromagnetic layer 2. The magnetic element 10 may be called an MTJ element, a GMR element, or other name depending on the material of the spacer layer 3, but is generally called a magnetoresistance effect element. The height of the entire magnetic element 10 in the z-axis direction is, for example, 15 nm to 40 nm, and preferably has a thickness of 20 nm or more in the stacking direction.

The magnetic element 10 may have a ferromagnetic material whose magnetization state changes when irradiated with light, and the resistance value may change with the change in the magnetization state. The magnetic element 10 may be, for example, the MTJ element and GMR element described above, as well as an anisotropic magnetoresistance (AMR) effect element, a colossal magnetoresistance (CMR) effect element, or the like.

The magnetic element 10 may be used together with a lens and placed at the focal position of the light in the band of use focused by the lens. It is preferable that the focal position of the light in the band of use overlaps, for example, with the first ferromagnetic layer 1. For example, when visible light is used, the magnetic element 10 is placed at the focal position of light in a specific wavelength range of 380 nm or more and less than 800 nm. Also, for example, when infrared light is used, the magnetic element 10 is placed at the focal position of light in a specific wavelength range of 800 nm or more and 1 mm or less. Also, for example, when ultraviolet light is used, the magnetic element 10 is placed at the focal position of light in a specific wavelength range of 200 nm or more and less than 380 nm.

The first ferromagnetic layer 1 is a light detection layer whose magnetization state changes when light is irradiated from the outside. The first ferromagnetic layer 1 is also called a magnetization free layer. The magnetization free layer is a layer containing a magnetic material whose magnetization state changes when a specific external energy is applied. The specific external energy is, for example, light irradiated from the outside, a current flowing in the z-axis direction of the magnetic element 10, an external magnetic field, etc. The magnetization M1 of the first ferromagnetic layer 1 changes state depending on the intensity of the irradiated light.

The first ferromagnetic layer 1 contains a ferromagnetic material. The first ferromagnetic layer 1 contains at least one of the magnetic elements such as Co, Fe, or Ni. The first ferromagnetic layer 1 may contain elements such as B, Mg, Hf, and Gd in addition to the magnetic elements described above. The first ferromagnetic layer 1 may be, for example, an alloy containing a magnetic element and a non-magnetic element. The first ferromagnetic layer 1 may be composed of multiple layers. The first ferromagnetic layer 1 may be, for example, a CoFeB alloy, a laminate in which a CoFeB alloy layer is sandwiched between Fe layers, or a laminate in which a CoFeB alloy layer is sandwiched between CoFe layers. In general, "ferromagnetic" includes "ferrimagnetic". The first ferromagnetic layer 1 may exhibit ferrimagnetic properties. Alternatively, the first ferromagnetic layer 1 may exhibit ferromagnetic properties that are not ferrimagnetic. For example, a CoFeB alloy exhibits ferromagnetic properties that are not ferrimagnetic.

The first ferromagnetic layer 1 may be an in-plane magnetized film with an easy axis of magnetization in the in-plane direction (any direction in the xy plane) or a perpendicular magnetized film with an easy axis of magnetization in the direction perpendicular to the film plane (z-axis direction).

The thickness of the first ferromagnetic layer 1 is, for example, 1 nm to 5 nm. The thickness of the first ferromagnetic layer 1 is preferably, for example, 1 nm to 2 nm. When the first ferromagnetic layer 1 is a perpendicular magnetized film, if the thickness of the first ferromagnetic layer 1 is thin, the effect of perpendicular magnetic anisotropy applied from the layers above and below the first ferromagnetic layer 1 is strengthened, and the perpendicular magnetic anisotropy of the first ferromagnetic layer 1 is enhanced. In other words, if the perpendicular magnetic anisotropy of the first ferromagnetic layer 1 is high, the force that causes the magnetization M1 to return to the z-axis direction is strengthened. On the other hand, if the thickness of the first ferromagnetic layer 1 is large, the effect of applying perpendicular magnetic anisotropy from the layers above and below the first ferromagnetic layer 1 becomes relatively weak, and the perpendicular magnetic anisotropy of the first ferromagnetic layer 1 becomes weak.

If the thickness of the first ferromagnetic layer 1 becomes thin, the volume of the ferromagnetic body becomes small, and if the thickness becomes thick, the volume of the ferromagnetic body becomes large. The responsiveness of the magnetization of the first ferromagnetic layer 1 when external energy is applied is inversely proportional to the product (KuV) of the magnetic anisotropy (Ku) and the volume (V) of the first ferromagnetic layer 1. In other words, if the product of the magnetic anisotropy and the volume of the first ferromagnetic layer 1 becomes small, the responsiveness to light increases. From this perspective, in order to increase the responsiveness to light, it is preferable to appropriately design the magnetic anisotropy of the first ferromagnetic layer 1 and then reduce the volume of the first ferromagnetic layer 1.

If the thickness of the first ferromagnetic layer 1 is thicker than 2 nm, an insertion layer made of, for example, Mo or W may be provided in the first ferromagnetic layer 1. In other words, the first ferromagnetic layer 1 may be a laminate in which a ferromagnetic layer, an insertion layer, and a ferromagnetic layer are stacked in the z-axis direction. The perpendicular magnetic anisotropy of the entire first ferromagnetic layer 1 is enhanced by the interface magnetic anisotropy at the interface between the insertion layer and the ferromagnetic layer. The thickness of the insertion layer is, for example, 0.1 nm to 1.0 nm.

The second ferromagnetic layer 2 is a magnetization fixed layer. The magnetization fixed layer is a layer made of a magnetic material whose magnetization state is less likely to change when a certain external energy is applied to it than the magnetization free layer. For example, the magnetization direction of the magnetization fixed layer is less likely to change when a certain external energy is applied to it than the magnetization free layer. In addition, for example, the magnetization of the fixed layer is less likely to change when a certain external energy is applied than that of the free layer. The coercive force of the second ferromagnetic layer 2 is, for example, greater than that of the first ferromagnetic layer 1. The second ferromagnetic layer 2 has an easy magnetization axis in the same direction as that of the first ferromagnetic layer 1. The second ferromagnetic layer 2 may be an in-plane magnetized film or a perpendicular magnetized film.

The material constituting the second ferromagnetic layer 2 is, for example, the same as that of the first ferromagnetic layer 1. The second ferromagnetic layer 2 may be, for example, a multilayer film in which Co having a thickness of 0.4 nm to 1.0 nm and Pt having a thickness of 0.4 nm to 1.0 nm are alternately stacked several times. The second ferromagnetic layer 2 may be, for example, a laminate in which Co having a thickness of 0.4 nm to 1.0 nm, The second ferromagnetic layer 2 may be, for example, a multilayer film in which Co having a thickness of 0.4 nm to 1.0 nm, Mo having a thickness of 0.1 nm to 0.5 nm, a CoFeB alloy having a thickness of 0.3 nm to 1.0 nm, and Fe having a thickness of 0.3 nm to 1.0 nm are laminated in this order.

The spacer layer 3 is a layer disposed between the first ferromagnetic layer 1 and the second ferromagnetic layer 2. The spacer layer 3 is composed of a layer composed of a conductor, an insulator, or a semiconductor, or a layer containing a current-carrying point composed of a conductor in an insulator. The spacer layer 3 is, for example, a non-magnetic layer. The thickness of the spacer layer 3 can be adjusted according to the orientation direction of the magnetization of the first ferromagnetic layer 1 and the magnetization of the second ferromagnetic layer 2 in the initial state described later.

When the spacer layer 3 is composed of an insulating material, a material containing aluminum oxide, magnesium oxide, titanium oxide, silicon oxide, or the like can be used as the material of the spacer layer 3. These insulating materials may also contain elements such as Al, B, Si, Mg, and magnetic elements such as Co, Fe, and Ni. By adjusting the thickness of the spacer layer 3 so that a high TMR effect is generated between the first ferromagnetic layer 1 and the second ferromagnetic layer 2, a high magnetoresistance change rate can be obtained. To efficiently utilize the TMR effect, the thickness of the spacer layer 3 may be about 0.5 nm to 5.0 nm, or about 1.0 nm to 2.5 nm.

When the spacer layer 3 is made of a non-magnetic conductive material, conductive materials such as Cu, Ag, Au, or Ru can be used. In order to efficiently utilize the GMR effect, the thickness of the spacer layer 3 may be about 0.5 nm to 5.0 nm, or about 2.0 nm to 3.0 nm.

When the spacer layer 3 is made of a non-magnetic semiconductor material, materials such as zinc oxide, indium oxide, tin oxide, germanium oxide, gallium oxide, or indium tin oxide (ITO) can be used. In this case, the thickness of the spacer layer 3 may be about 1.0 nm to 4.0 nm.

When a layer including a current-carrying point formed by a conductor in a non-magnetic insulator is used as the spacer layer 3, a structure including a current-carrying point formed by a non-magnetic conductor such as Cu, Au, or Al in a non-magnetic insulator made of aluminum oxide or magnesium oxide may be used. The conductor may also be made of magnetic elements such as Co, Fe, and Ni. In this case, the thickness of the spacer layer 3 may be about 1.0 nm to 2.5 nm. The current-carrying point is, for example, a columnar body with a diameter of 1 nm to 5 nm when viewed from a direction perpendicular to the film surface.

The cap layer 4 is provided between the first ferromagnetic layer 1 and the first electrode 11. The cap layer 4 may include a perpendicular magnetization induction layer (not shown) that is stacked on the first ferromagnetic layer 1 and in contact with the first ferromagnetic layer 1. The cap layer 4 prevents damage to the lower layer during the manufacturing process and enhances the crystallinity of the lower layer during annealing. The thickness of the cap layer 4 is, for example, 10 nm or less so that the first ferromagnetic layer 1 is irradiated with sufficient light.

The insulating layer 16 is provided between the first electrode 11 and the second electrode 12 or the cap layer 13, and is formed so as to cover the periphery of the magnetic element 10. The insulating layer 16 is, for example, an oxide, nitride, or oxynitride of Si, Al, or Mg. The insulating layer 16 is, for example, silicon oxide (SiOₓ), silicon nitride (SiNₓ), silicon carbide (SiC), chromium nitride, silicon carbonitride (SiCN), silicon oxynitride (SiON), aluminum oxide (Al₂O₃), zirconium oxide (ZrOₓ), etc.

The first electrode 11 is, for example, disposed on the upper side of the magnetic element 10. Incident light is irradiated to the magnetic element 10 from the first electrode 11 side, and is irradiated to at least the first ferromagnetic layer 1. The first electrode 11 is made of a material having electrical conductivity. The first electrode 11 is, for example, a transparent electrode that is transparent to light in the wavelength range used. The first electrode 11 preferably transmits, for example, 80 % or more of light in the wavelength range used. The first electrode 11 is, for example, an oxide such as indium tin oxide (ITO), indium zinc oxide (IZO), zinc oxide (ZnO), or indium gallium zinc oxide (IGZO). The first electrode 11 may be configured to have a plurality of columnar metals in the transparent electrode material of these oxides.

It is not essential to use the above-mentioned transparent electrode material for the first electrode 11, and a metal material such as Au, Cu, or Al may be used with a thin film thickness so that the irradiated light reaches the first ferromagnetic layer 1. When a metal is used as the material for the first electrode 11, the film thickness of the first electrode 11 is, for example, 3 nm to 10 nm. The first electrode 11 may also have an anti-reflection film on the light-irradiated surface.

The second electrode 12 is made of a material having electrical conductivity. The second electrode 12 is made of a metal such as Cu, Al, or Au. Ta or Ti may be laminated above and below these metals. Also, a laminated film of Cu and Ta, a laminated film of Ta, Cu, and Ti, or a laminated film of Ta, Cu, and TaN may be used. Also, TiN or TaN may be used as the second electrode 12. The film thickness of the second electrode 12 is, for example, 200 nm to 800 nm.

The second electrode 12 may be transparent to the light irradiated to the magnetic element 10. As the material of the second electrode 12, like the first electrode 11, for example, a transparent electrode material of oxide such as indium tin oxide (ITO), indium zinc oxide (IZO), zinc oxide (ZnO), or indium gallium zinc oxide (IGZO) may be used. Even when light is irradiated from the first electrode 11, the light may reach the second electrode 12 depending on the intensity of the light. In this case, since the second electrode 12 is configured to include a transparent electrode material of oxide, the reflection of light at the interface between the second electrode 12 and the layer in contact therewith can be suppressed compared to when the second electrode 12 is configured of a metal.

Returning to FIGS. 1 and 2, the antenna portion 20 is composed of a plurality of metal rings 21 and 22 formed on the surface 12a of the second electrode 12 on the magnetic element 10 side, with the magnetic element 10 as the light detection portion at the center. The number of metal rings may be one or three or more. By providing the antenna portion 20 on the side of the magnetic element 10, the sensitivity of the light detection element 100 can be improved by utilizing plasmon resonance to focus light in an area narrower than the diffraction limit of light. The antenna portion 20 is, for example, a plasmon antenna or a bull's-eye antenna. The antenna portion 20 may contain at least one element selected from the group consisting of Pt, Au, Ag, and Cu. By selecting an appropriate material for the antenna portion 20, it is possible to efficiently induce plasmons and improve the coupling efficiency with the magnetic element 10.

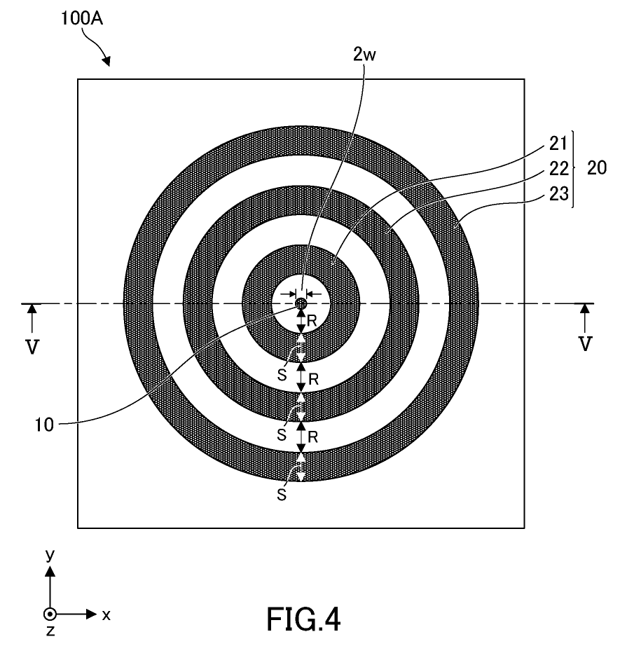

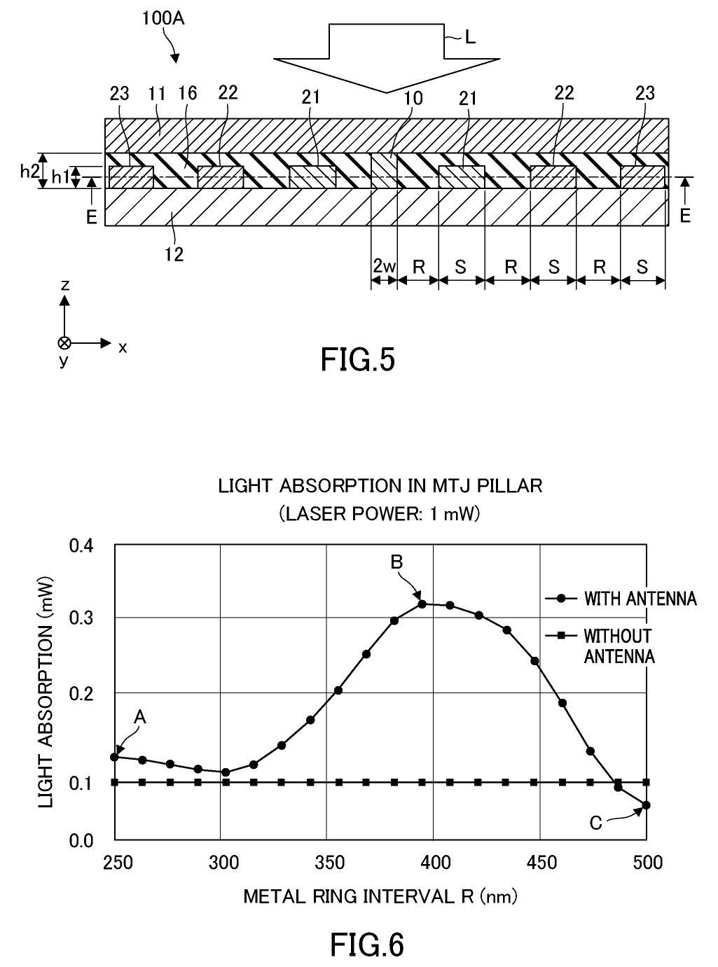

FIG. 4 is a plan view showing the configuration of the light detection element 100A used in Simulation 1, and FIG. 5 is a cross-sectional view taken along line V-V in FIG. 4. The magnetic element 10 of the light detection element 100A is composed of an MTJ pillar, and the height h2 in the z-axis direction is 40 nm, and the radius w of the circular shape in the plan view from the z-axis direction is 100 nm. For example, if the MTJ pillar is a mesa type and the size of the upper surface of each layer constituting the magnetic element 10 is not the same, the radius w of the circular shape in the plan view from the z-axis direction of the magnetic element 10 may be, for example, the radius of the circular shape in the plan view from the z-axis direction of the first ferromagnetic layer 1 (same below). The antenna portion 20 is composed of three metal rings 21, 22, and 23 formed on the surface 12a of the second electrode 12 on the magnetic element 10 side with the magnetic element 10 at the center. The metal rings 21, 22, and 23 are made of Au, and the thickness h1 in the z-axis direction is 35 nm. The intervals R between adjacent metal rings are all the same. The widths S of the respective metal rings 21, 22, and 23 are also made identical to one another, and the width S is set equal to the metal-ring interval R (S = R). The interval between the magnetic element 10 and the innermost metal ring 21 is also the same as the metal ring interval R. The first electrode 11 is made of ITO, and the second electrode 12 has a multilayer structure in which a Ta layer, a Ru layer, and a Ta layer are stacked. The insulating layer 16 is made of Al₂O₃.

FIG. 6 is a graph showing the simulation results of the relationship between the metal ring interval R of the antenna portion 20 and the amount of light absorption of the MTJ pillar. The simulation was performed with the configuration of the light detection element 100A shown in FIGS. 4 and 5. The incident light L was a Gaussian beam with a wavelength λ = 1064 nm and a power of 1 mW, and the diameter of the narrowest point was 3.7 μm. At point A where the metal ring interval R is 250 nm, the light absorption is slightly higher than when there is no antenna portion, and at point C where the metal ring interval R is 500 nm, the light absorption is slightly lower than when there is no antenna portion. At point B where the metal ring interval R is around 400 nm, the light absorption (sensitivity) is improved by about three times.

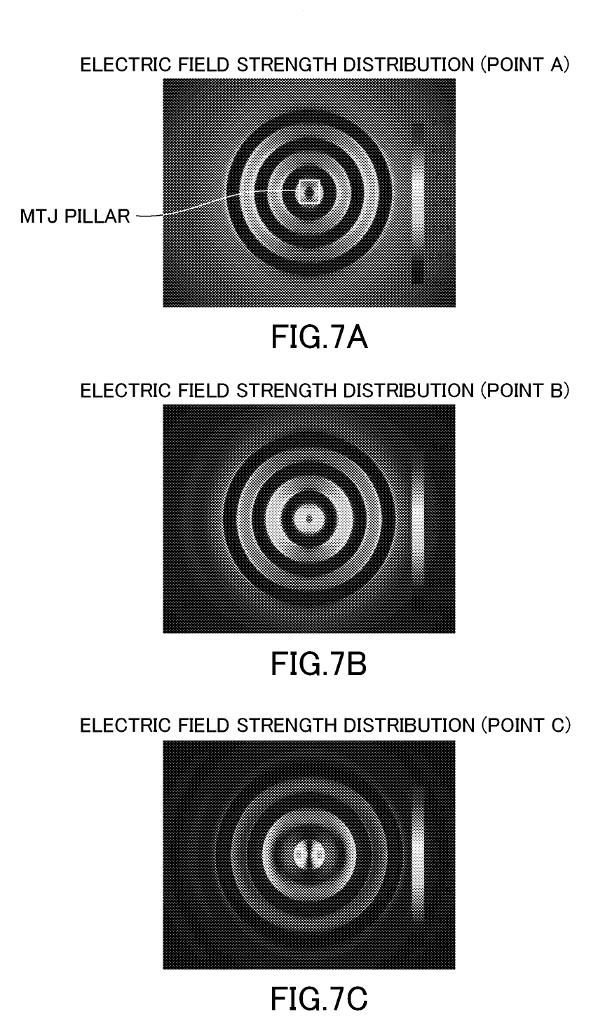

FIGS. 7A, 7B, and 7C show the electric field strength distribution (arbitrary unit) obtained by simulation for points A, B, and C in FIG. 6. The electric field strength distribution was calculated on the cross section cut by line E-E in FIG. 5. As shown in FIGS. 7A, 7B, and 7C, the electric field strength at the MTJ pillar is the highest under the condition of point B.

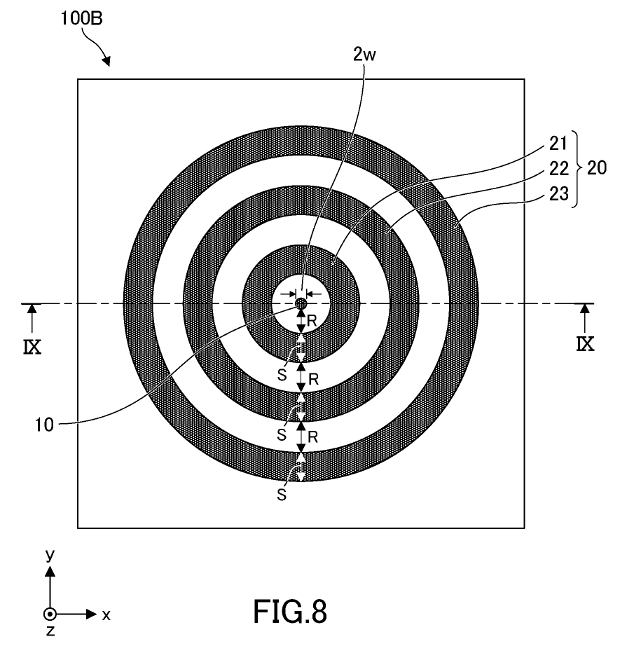

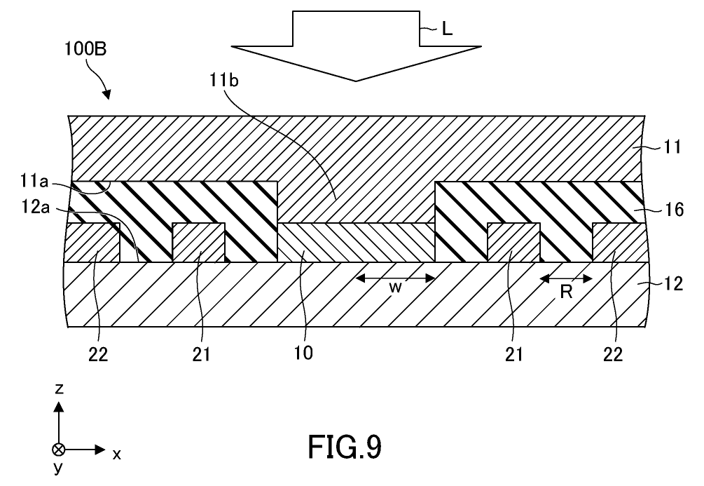

FIG. 8 is a plan view showing the configuration of the light detection element 100B used in Simulation 2, and FIG. 9 is a cross-sectional view taken along line IX-IX in FIG. 8. The magnetic element 10 of the light detection element 100B is composed of an MT J pillar, the height in the z-axis direction is 20 nm, and the radius w of the circular shape in plan view from the z-axis direction is 100 nm. The antenna portion 20 is composed of three metal rings 21, 22, and 23 formed on the surface 12a of the second electrode 12 on the magnetic element 10 side, with the magnetic element 10 at the center. The metal rings 21, 22, and 23 are made of Au, and the thickness in the z-axis direction is 20 nm. The intervals R between adjacent metal rings are all the same. The widths S of the metal rings 21, 22, and 23 are also the same, and the width S is the same as the metal ring interval R (S = R). The interval between the magnetic element 10 and the innermost metal ring 21 is also the same as the metal ring interval R. The first electrode 11 is made of ITO, the thickness in the z-axis direction is 45 nm, and the thickness of the protrusion 11b is 5 nm. The second electrode 12 has a multilayer structure in which a 5 nm thick Ta layer, a 60 nm thick Ru layer, and a 5 nm thick Ta layer are stacked. The insulating layer 16 is made of Al₂O₃.

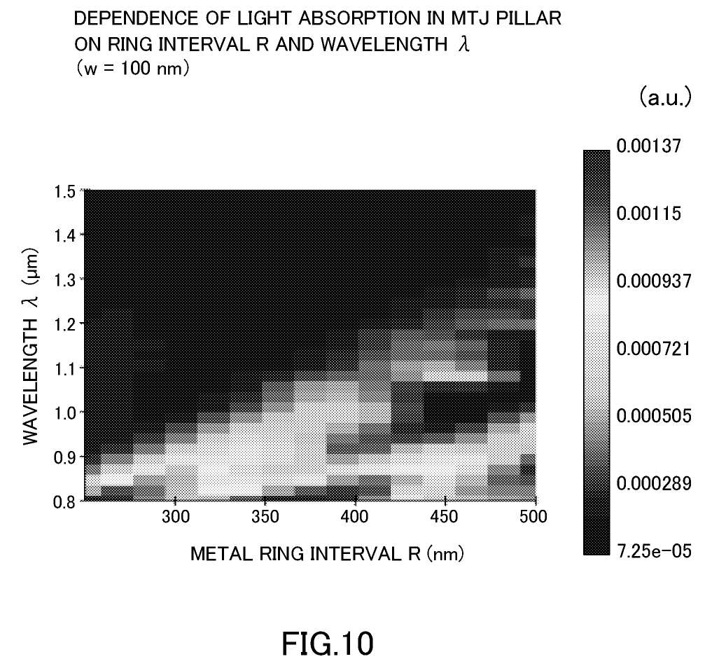

FIG. 10 shows the simulation results of the dependence of the light absorption amount (arbitrary unit) of the MTJ pillar on the metal ring interval R and the wavelength λ. The simulation was performed using the light detection element 100B configuration shown in FIGS. 8 and 9. The radius w of the MTJ pillar was set to w = 100 nm. From FIG. 10, it can be seen that the light absorption amount of the MTJ pillar is high in the two stripe regions where the wavelength λ increases as the metal ring interval R increases.

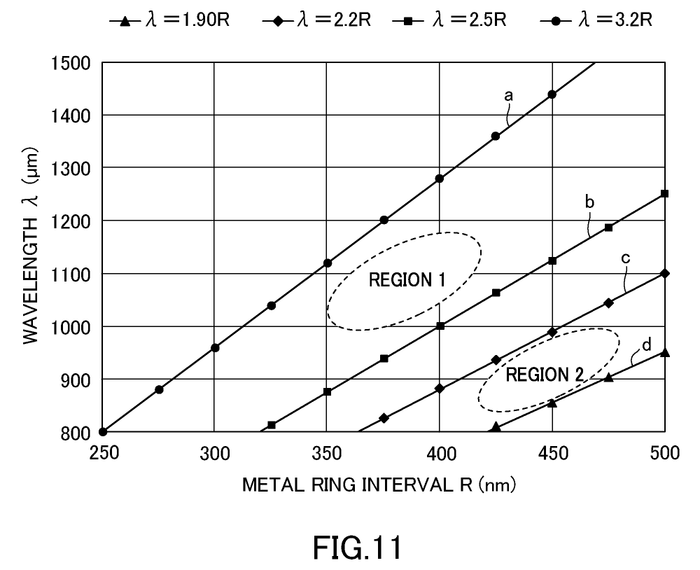

FIG. 11 shows the preferred ranges of the metal ring interval R and the wavelength λ to be adopted from the simulation results of FIG. 10. To identify the two stripe regions in FIG. 10, the borders of the stripe regions are shown in a graph with the metal ring interval R on the horizontal axis and the wavelength λ on the vertical axis. As shown in FIG. 11, region 1 corresponding to one of the strip regions in FIG. 10 is sandwiched between boundary line a of λ = 3.2R and boundary line b of λ = 2.5R. Region 2 corresponding to the other strip region in FIG. 10 is sandwiched between boundary line c of λ= 2.2R and boundary line d of λ= 1.9R.

In more detail, each of the multiple metal rings 21, 22, 23 has a concentric ring shape in a plan view from the light incidence direction. When the interval R [nm] between adjacent metal rings among the multiple metal rings 21, 22, 23 and the wavelength λ [nm] of the incident light satisfy the following conditions, the amount of light absorption in the MTJ pillar increases.

2.5R < λ < 3.2R, or 1.9R < λ < 2.2R (Condition 1)

By setting the dimensions of the antenna portion 20 within an appropriate range for the incident light, it is possible to effectively focus the light on the magnetic element 10.

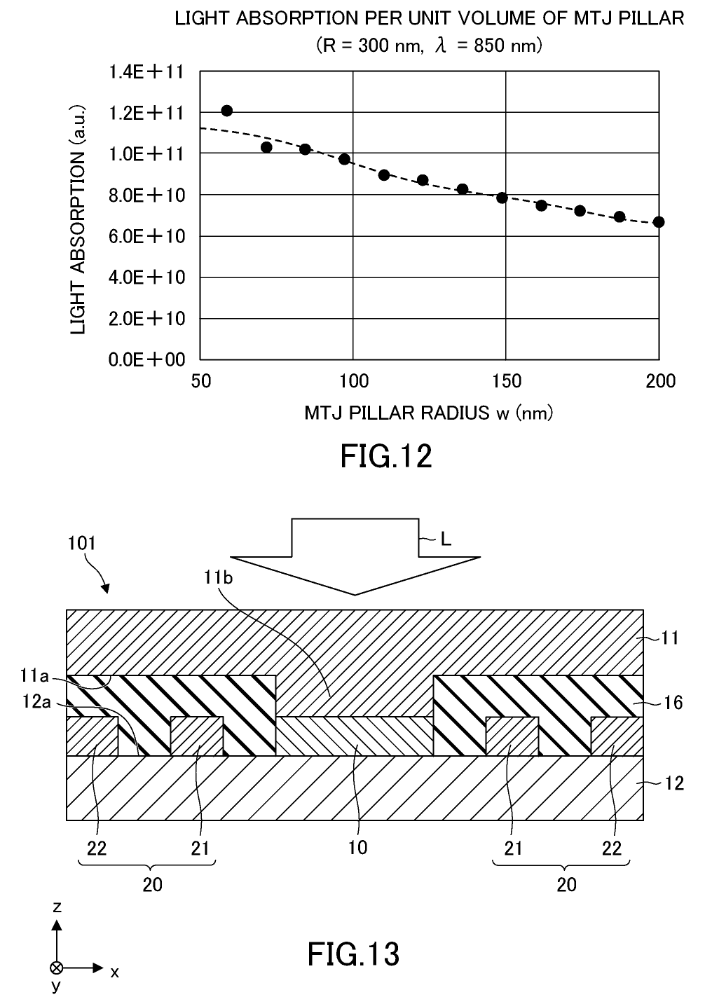

FIG. 12 is a graph showing the simulation results of the relationship between the MTJ pillar radius w and the amount of light absorption (arbitrary units) per unit volume of the MTJ pillar. The model used in Simulation 3 is the same as the light detection element 100B shown in FIGS. 8 and 9. The interval R between the metal rings of the antenna portion 20 is 300 nm, and the wavelength λ of the incident light (plane wave) is 850 nm. As can be seen from FIG. 12, the smaller the MTJ pillar radius w, the greater the amount of light absorption, so it is desirable to have a smaller MTJ pillar radius w, but the effect of the MTJ pillar radius w on the amount of light absorption is not that great.

Each of the multiple metal rings 21, 22, 23 has a concentric ring shape in plan view from the light incidence direction, and the magnetic element 10 (MTJ pillar) as a light detection portion is a circle in plan view from the light incidence direction. As a premise, the relationship between the interval R [nm] between adjacent metal rings among the multiple metal rings 21, 22, 23 and the radius w [nm] of the circle in plan view of the magnetic element 10 is w < R (Condition 2). By setting the dimensions of the antenna portion 20 within an appropriate range for the incident light, it is possible to effectively focus the light on the magnetic element 10. The absorption condition does not depend much on the height of the MTJ pillar or the material of the metal rings.

Returning to FIGS. 1-3, the light detection element 100 according to the first embodiment is obtained by sequentially fabricating the second electrode 12, the magnetic element 10, the antenna portion 20, the insulating layer 16, and the first electrode 11.

The magnetic element 10 is fabricated by a process of stacking each layer, an annealing process, a processing process, etc. First, the cap layer 13, the second ferromagnetic layer 2, the spacer layer 3, the first ferromagnetic layer 1, and the cap layer 4 are sequentially laminated on the second electrode 12. Each layer is formed by, for example, sputtering.

Then, the laminated film is annealed. The annealing temperature is, for example, 250° C to 400° C. Then, the laminated film is processed into a columnar laminate 15 by, for example, photolithography and etching. The laminate 15 may be in the shape of a mesa, a cylinder, a prism, a truncated cone, a truncated pyramid, or the like, either as a whole or as each layer. The shortest width of the laminate 15 as viewed in the z-axis direction is, for example, 10 nm to 1000 nm.

Next, a layer made of a material constituting the antenna portion 20 is formed around the laminate 15 by sputtering. Then, the antenna portion 20 is formed of concentric metal rings 21 and 22 by, for example, photolithography and etching.

Next, an insulating layer 16 is formed so as to cover the side surface of the laminate 15 and the side surface and upper surface of the antenna portion 20. The insulating layer 16 may be laminated multiple times. Next, the upper surface of the cap layer 4 is exposed from the insulating layer 16 by, for example, chemical mechanical polishing, and a first electrode layer is formed on the cap layer 4 and the insulating layer 16 by sputtering. The first electrode layer is processed, for example, by photolithography and etching, into a columnar or plate-shaped first electrode 11, such as a cylindrical shape, a prismatic shape, a truncated cone shape, or a truncated pyramid shape.

An insulating layer may be formed on the first electrode 11, and a lens such as a metalens may be formed on the insulating layer. The above process results in a light detection element 100. In this manner, in the manufacture of the light detection element 100, the second electrode 12, the magnetic element 10, the antenna portion 20, and the first electrode 11 can be continuously formed by a vacuum film formation process.

Next, the operation of the light detection element 100 according to the first embodiment will be described.

As shown in FIG. 2, incident light L on the light detection element 100 passes through the transparent first electrode 11 and is irradiated onto the magnetic element 10, particularly the first ferromagnetic layer 1. When the intensity of the light irradiated to the first ferromagnetic layer 1 changes, the state of the magnetization M1 of the first ferromagnetic layer 1 changes. The state of the magnetization M1 is, for example, the tilt angle of the magnetization M1 with respect to the z-axis direction, the magnitude of the magnetization M1, etc.

For example, when the intensity of the light irradiated to the first ferromagnetic layer 1 increases, the magnetization M1 of the first ferromagnetic layer 1 tilts from its initial state due to the external energy caused by the light irradiation. The angle between the direction of the magnetization M1 of the first ferromagnetic layer 1 when the first ferromagnetic layer 1 is not irradiated with light and the direction of the magnetization M1 when the first ferromagnetic layer 1 is irradiated with light is, for example, greater than 0° and less than 90°. Alternatively, for example, when the intensity of the light irradiated to the first ferromagnetic layer 1 increases, the magnitude of the magnetization M1 decreases.

When the state of the magnetization M1 of the first ferromagnetic layer 1 changes, the resistance value of the magnetic element 10 in the z-axis direction changes due to the magnetoresistance effect. When a constant current (sense current) is passed through the magnetic element 10 in the positive or negative direction of the z-axis using the first electrode 11 and the second electrode 12, an output voltage is obtained from the magnetic element 10. In other words, when the state of the magnetization M1 of the first ferromagnetic layer 1 changes, the output voltage from the magnetic element 10 also changes.

The intensity of the light irradiated to the first ferromagnetic layer 1 may take two values, for example, a first intensity and a second intensity. The first intensity may be the case where the intensity of the light irradiated to the first ferromagnetic layer 1 is zero. The intensity of the light irradiated to the first ferromagnetic layer 1 may take multiple values or may change analogically. When the intensity of the incident light is multi-valued, the output voltage of the magnetic element 10 can also be multi-valued, and when the intensity of the light changes in an analog manner, the output voltage of the magnetic element 10 can also be changed in an analog manner. The difference in these output voltages (resistance values) can be read out from the light detection element 100 as binary, multi-valued, or analog data.

In a state where the first ferromagnetic layer 1 is irradiated with light of a first intensity (or zero intensity) (referred to as the "initial state"), the magnetization M1 of the first ferromagnetic layer 1 and the magnetization M2 of the second ferromagnetic layer 2 may be parallel or anti-parallel, or the magnetization M1 and the magnetization M2 may be perpendicular to each other.

When the magnetization M1 and the magnetization M2 are parallel in the initial state, a sense current is passed from the first ferromagnetic layer 1 to the second ferromagnetic layer 2. By passing the sense current in this direction, a spin transfer torque in the same direction as the magnetization M2 of the second ferromagnetic layer 2 acts on the magnetization M1 of the first ferromagnetic layer 1, and the magnetization M1 and the magnetization M2 become parallel in the initial state. In addition, by passing the sense current in this direction, it is possible to prevent the magnetization M1 of the first ferromagnetic layer 1 from being reversed during operation.

When the magnetization M1 and the magnetization M2 are antiparallel in the initial state, it is preferable to pass the sense current from the second ferromagnetic layer 2 to the first ferromagnetic layer 1. By passing the sense current in this direction, a spin transfer torque in the opposite direction to the magnetization M2 of the second ferromagnetic layer 2 acts on the magnetization M1 of the first ferromagnetic layer 1, and the magnetization M1 and the magnetization M2 become antiparallel in the initial state.

When the intensity of the light irradiated to the first ferromagnetic layer 1 returns to the first intensity, a spin transfer torque is generated by the sense current, or the state of the magnetization M1 of the first ferromagnetic layer 1 returns to the original state by the action of magnetic anisotropy, and the magnetic element 10 returns to the initial state.

In this way, the light detection element 100 according to the first embodiment can convert the change in the intensity of the irradiated light into a change in the output voltage from the magnetic element 10. In other words, the light detection element 100 can convert light into an electric signal.

As described above, in the first embodiment of the present disclosure, by providing the antenna portion 20 on the side of the magnetic element 10 as the center, the sensitivity of the light detection element 100 can be improved by utilizing plasmon resonance to focus light in an area narrower than the diffraction limit of light.

Next, a second embodiment of the present disclosure will be described. In the second embodiment, the height of the magnetic element 10 in the z-axis direction is different from that in the first embodiment. The other configuration is the same as in the first embodiment, and the same components are given the same reference numerals and the description is omitted as appropriate.

FIG. 13 is a cross-sectional view showing the configuration of a light detection element 101 according to the second embodiment of the present disclosure. As shown in FIG. 13, in the light detection element 101, the height of the magnetic element 10 in the z-axis direction is smaller than the distance between the first electrode 11 and the second electrode 12. The first electrode 11 has a cylindrical protrusion 11b whose portion in contact with the magnetic element 10 protrudes downward. The thickness in the z-axis direction of each of the metal rings 21 and 22 of the antenna portion 20 is, for example, 10 nm to 100 nm, with the distance between the first electrode 11 and the second electrode 12 as the limit, and may be equal to the height of the magnetic element 10.

The material constituting each element of the light detection element 101 may be the same as the material of the corresponding element of the light detection element 100 of the first embodiment. The magnetic element 10 of the light detection element 101 is, for example, an M-TJ pillar. The metal rings 21 and 22 constituting the antenna portion 20 are, for example, made of Au. The first electrode 11 is, for example, made of ITO. The second electrode 12 is, for example, a multilayer structure in which a Ta layer, a Ru layer, and a Ta layer are stacked. The insulating layer 16 is, for example, made of Al₂O₃.

Even if the height of the magnetic element 10 in the z-axis direction is smaller than the distance between the first electrode 11 and the second electrode 12, the first electrode 11 is provided with a protrusion 11b, so that the incident light L can be effectively irradiated to the magnetic element 10. Furthermore, by providing the antenna portion 20 in a circular ring shape around the magnetic element 10, it is possible to utilize plasmon resonance to focus light in an area narrower than the diffraction limit of light, thereby improving the sensitivity of the light detection element 101.

A third embodiment of the present disclosure will be described. In the third embodiment, the configuration of the antenna portion 20 differs from that of the first and second embodiments. The rest of the configuration is the same as that of the first and second embodiments, and the same components are given the same reference numerals and descriptions will be omitted as appropriate.

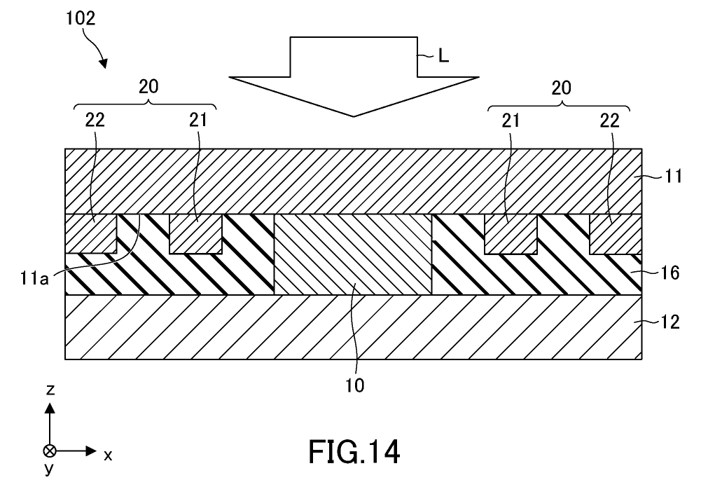

FIG. 14 is a cross-sectional view showing the configuration of a light detection element 102 according to the third embodiment of the present disclosure. As shown in FIG. 14, in the light detection element 102, the metal rings 21 and 22 of the antenna portion 20 are provided on the surface 11a of the first electrode 11 facing the magnetic element 10. The height of the magnetic element 10 in the z-axis direction is equal to the distance between the first electrode 11 and the second electrode 12. The material constituting each element of the light detection element 102 may be the same as the material of the corresponding element of the light detection element 100 of the first embodiment.

Even if the metal rings 21 and 22 of the antenna portion 20 are provided on the surface 11a of the first electrode 11 facing the magnetic element 10, the antenna portion 20 is provided in a ring shape around the magnetic element 10, so that the light can be focused in an area narrower than the diffraction limit of light by utilizing plasmon resonance, thereby improving the sensitivity of the light detection element 102.

The light detection elements 100 to 102 of the first to third embodiments can be applied to, for example, an optical sensor such as an image sensor in which a plurality of light detection elements are arranged one-dimensionally or two-dimensionally. Such an optical sensor can be used in information terminal devices such as smartphones, tablets, personal computers, and digital cameras.

Furthermore, the light detection elements 100 to 102 of the first to third embodiments can be applied to, for example, a photoelectric conversion element of a receiving apparatus provided in a transmission/reception apparatus that transmits and receives optical signals such as laser light in a communication system in which a plurality of transmission/reception apparatuses are connected by optical fibers. The above communication system may be, for example, a communication system that performs short- or medium-distance communication such as within a data center or between data centers, or long-distance communication such as between cities. The transmission/reception apparatus is installed, for example, in a data center.

The above communication system may be a communication system for wirelessly transmitting and receiving optical signals, such as near-infrared light, between mobile terminals such as smartphones and tablets. The above communication system may be a communication system for wirelessly transmitting and receiving optical signals, such as near-infrared signal, between a mobile terminal and an information processing device such as a personal computer.

The present disclosure is not limited to the above embodiment, and various modifications and changes are possible within the scope of the gist of the present disclosure described in the claims.

As described above, the present disclosure has the effect of improving the sensitivity of the photodetection element by providing an antenna portion on the side of a magnetic element (MTJ pillar, etc.) as a photodetection unit, utilizing plasmon resonance to focus light in an area narrower than the diffraction limit of light, and is useful for photodetection elements in general.

### APPENDIX

One aspect of the present disclosure provides a light detection element according to the present disclosure comprises a light detection portion for detecting light, a first electrode having optical transparency that is light-transmissive, a second electrode, and an antenna portion, the light detection portion being located between the first electrode and the second electrode, and the antenna portion being made of one or more metal rings formed on the surface of either the first electrode or the second electrode facing the light detection portion, with the light detection portion at the center.

With this configuration, the light detection element of the present disclosure can improve the sensitivity of the light detection element by using plasmon resonance to focus light in an area narrower than the diffraction limit of light by providing an antenna portion on the side of a light detection element such as an MTJ pillar as the center.

One aspect of the present disclosure provides the light detection element, wherein when the light detection element of the present disclosure has a plurality of metal rings, each of the plurality of metal rings may be concentrically annular in a plan view from the direction of incidence of the light, and the relationship of 2.5R < λ < 3.2R or 1.9R < λ < 2.2R may be satisfied, where R is the interval between adjacent metal rings among the plurality of metal rings and λ is the wavelength of the light.

With this configuration, the light detection element of the present disclosure can effectively focus light on the light detection element by setting the dimensions of the antenna portion within an appropriate range for the incident light.

One aspect of the present disclosure provides the light detection element according to the present disclosure wherein when there are a plurality of metal rings, each of the plurality of metal rings has a concentric ring shape in a plan view from the direction of incidence of the light, the light detection portion has a circular shape in a plan view from the direction of incidence of the light, and the relationship between the interval R between adjacent metal rings among the plurality of metal rings and the radius w of the circle in a plan view of the light detection portion is w < R.

With this configuration, the light detection element according to the present disclosure can effectively focus light on the light detection element by setting the dimensions of the antenna portion within an appropriate range for the incident light.

One aspect of the present disclosure provides the light detection element according to the present disclosure, wherein the light detection portion may include a first ferromagnetic layer, a second ferromagnetic layer, and a spacer layer sandwiched between the first ferromagnetic layer and the second ferromagnetic layer.

With this configuration, the light detection element of the light detection element of the present disclosure functions effectively as a magnetoresistance effect element such as an MTJ element. Specifically, the magnetization state of the first ferromagnetic layer changes due to irradiation with light, and the resistance value of the light detection element changes with the change in magnetization state, so that the irradiated light can be detected as an electrical signal.

One aspect of the present disclosure provides the light detection element of the present disclosure, wherein the antenna portion may include at least one element selected from the group consisting of Pt, Au, Ag, and Cu.

With this configuration, the light detection element of the present disclosure can efficiently induce plasmons and improve the coupling efficiency with the light detection element by using an appropriate material for the antenna portion.

Although the disclosure has been described with respect to only a limited number of embodiments, those skilled in the art, having benefit of this disclosure, will appreciate that various other embodiments may be devised without departing from the spirit and scope of the present disclosure. Accordingly, the technical scope of the disclosed subject matter should be limited only by the attached claims.

### DESCRIPTION OF REFERENCE NUMERALS AND SIGNS

1 First ferromagnetic layer
2 Second ferromagnetic layer
3 Spacer layer
4, 13 Cap layer
10 Magnetic element (light detection portion)
11 First electrode
11a, 12a Surface
11b Protrusion
12 Second electrode
15 Laminate
16 Insulating layer
20 Plasmon antenna (antenna portion)
21, 22, 23 Metal ring
100, 100A, 100B, 101, 102 Light detection element
M1, M2 magnetization

What is claimed is:

1. A light detection element comprising a light detection portion for detecting light, a first electrode having optical transparency, a second electrode, and an antenna portion,
wherein the light detection portion is located between the first electrode and the second electrode, and the antenna portion is composed of one or more metal rings formed on the surface of either the first electrode or the second electrode facing the light detection portion with the light detection portion at the center.

2. The light detection element according to claim 1, wherein
when a plurality of the metal rings are provided, each of the plurality of the metal rings has a concentric ring shape in a plan view from the incident direction of the light, and a relationship of 2.5R < λ < 3.2R or 1.9R < λ < 2.2R is satisfied, where R is the interval between adjacent metal rings among the multiple metal rings and λ is the wavelength of the light.

3. The light detection element according to claim 1, wherein
when a plurality of the metal rings are provided, each of the plurality of the metal rings has a concentric ring shape in a plan view from the incident direction of the light, the light detection portion has a circular shape in a plan view from the incident direction of the light, and a relationship of w < R is satisfied, where R is the interval between adjacent metal rings among the plurality of the metal rings, and w is the radius of the circular shape in the plan view of the light detection portion.

4. The light detection element according to claim 1, wherein when a plurality of the metal rings are provided, each of the plurality of the metal rings has a concentric ring shape in a plan view from the incident direction of the light, and intervals between adjacent ones of the plurality of the metal rings are all identical.

5. The light detection element according to claim 1, wherein when a plurality of the metal rings are provided, each of the plurality of the metal rings has a concentric ring shape in a plan view from the incident direction of the light, and widths of the respective ones of the plurality of the metal rings are identical to one another.

6. The light detection element according to claim 1, wherein the light detection portion includes a first ferromagnetic layer, a second ferromagnetic layer, and a spacer layer sandwiched between the first ferromagnetic layer and the second ferromagnetic layer.

7. The light detection element according to claim 6, wherein the first ferromagnetic layer includes at least one of Co, Fe, or Ni.

8. The light detection element according to claim 6, wherein the first ferromagnetic layer is any one of a CoFeB alloy, a laminate in which a CoFeB alloy layer is sandwiched by Fe layers, or a laminate in which a CoFeB alloy layer is sandwiched by CoFe layers.

9. The light detection element according to claim 6, wherein the spacer layer includes aluminum oxide, magnesium oxide, titanium oxide, or silicon oxide.

10. The light detection element according to claim 1, wherein the antenna portion includes at least one element selected from the group consisting of Pt, Au, Ag, and Cu.

11. The light detection element according to claim 1, wherein the first electrode is formed of indium tin oxide (ITO), indium zinc oxide (IZO), zinc oxide (ZnO), or indium gallium zinc oxide (IGZO).

12. The light detection element according to claim 1, wherein the second electrode is formed of a Ta/Ru/Ta multilayer film.

13. The light detection element according to claim 1, further comprising an insulating layer that is provided between the first electrode and the second electrode and is formed so as to cover a periphery of the light detection portion.

14. The light detection element according to claim 13, wherein the insulating layer is formed of aluminum oxide.

15. The light detection element according to claim 1, wherein the first electrode has a cylindrical protrusion whose portion in contact with the light detection portion protrudes downward.

16. The light detection element according to claim 15, wherein a thickness of each of the metal rings of the antenna portion is equal to a height of the light detection portion.

17. The light detection element according to claim 15, wherein the light is irradiated onto the light detection portion from the first electrode side.

18. A method for manufacturing a light detection element, the method comprising:
laminating, in this order, a second ferromagnetic layer, a spacer layer, and a first ferromagnetic layer on a second electrode;
annealing a laminated film including the laminated second ferromagnetic layer, the spacer layer, and the first ferromagnetic layer at an annealing temperature of 250° C to 400° C;
processing the laminated film into a laminate having a columnar shape to form a light detection portion;
forming one or more metal rings around the light detection portion on the side of the second electrode facing the light detection portion;
forming an insulating layer so as to cover a side surface of the light detection portion and side and upper surfaces of an antenna portion composed of the one or more metal rings; and
forming a light‑transmissive first electrode on the first ferromagnetic layer and the insulating layer.

19. A communication system comprising a plurality of transmission/reception apparatuses that transmit and receive optical signals, each of the transmission/reception apparatuses including a receiving apparatus having the light detection element according to claim 1.

20. The communication system according to claim 19, wherein the optical signal is a near‑infrared signal.
